(19) United States
(12) Patent Application Publication
(10) Pub. No.: US 2026/0342094 A1
(43) Pub. Date: Oct. 29, 2026

(54) Methods of Grid Balancing Using Batteries of Electric Vehicles

(71) Applicant: Harbinger Motors Inc., Garden Grove, CA (US)

(72) Inventor: John Henry Harris, III, Anaheim, CA (US)

(21) Appl. No.: 19/467,167

(22) Filed: Feb. 2, 2026

Related U.S. Application Data
(60) Provisional application No. 63/793,962, filed on Apr. 24, 2025.

(51) Int. Cl. H02J 3/32; B60L 53/62; B60L 53/66; B60L 55/00; B60L 58/12

(52) U.S. Cl. CPC H02J 3/322; B60L 53/62; B60L 53/66; B60L 55/00; B60L 58/12

(57) ABSTRACT

Described herein are methods for balancing electrical grids using balancing units, which may be parts of the electrical grids or operated as independent services. A method may involve forming a system-vehicle communication channel between the grid balancing unit/system and one or more electric vehicle units, each comprising an electric vehicle with a battery. The method may proceed with receiving a set of vehicle unit parameters, such as the vehicle's location, vehicle's power transmission limit, battery capacity, current state of charge (SOC), and the like. The balance unit then generates the current power/energy availabilities from these vehicle units (and based on the received vehicle unit parameters). This information can then be used by the grid to selectively charge/discharge the batteries of one or more vehicles for grid balancing purposes. The selection of vehicles and charge/discharge parameters (e.g., timing, power) depends on the vehicle unit parameters.

### CROSS-REFERENCE TO RELATED APPLICATIONS

This application claims the benefit under 35 U.S.C. § 119(e) of US Provisional Patent Application 63/793,962, filed on Apr. 24, 2025, which is incorporated herein by reference in its entirety for all purposes.

### FIELD OF TECHNOLOGY

This patent application relates generally to methods for balancing electrical grids using grid balancing units and electric vehicles (i.e., their batteries) positioned within grid boundaries.

### BACKGROUND

Electrical grids have a need for grid balancing for several reasons. Storage of electrical power generated at times of peak generation by renewable sources exceeding grid demand may be stored temporarily and released to the grid during times of lower generation and higher demand. Furthermore, the stored energy can be released during periods of unexpected demand while additional power generation equipment is being started up. The stored energy can also be released to the grid to compensate for unplanned losses of power generation in cases of equipment failure or natural disasters. While energy demand increases during daytime hours and decreases during nighttime hours, and varies with weather conditions, grid storage capacity can allow electrical grid operators to meet the varying demand while varying the output of power-generating equipment less dramatically. Large-capacity grid electrical storage may be used to provide grid balancing. However, capital costs to construct large-capacity grid electrical storage may be prohibitive for electrical grid operators. Furthermore, aggregating all battery storage in the same location is not desirable from the safety and energy transmission perspectives.

### SUMMARY

Described herein are methods for balancing electrical grids using balancing units, which may be parts of the electrical grids or operated as independent services. A method may involve forming a system-vehicle communication channel between the grid balancing unit/system and one or more electric vehicle units, each comprising an electric vehicle with a battery. The method may proceed with receiving a set of vehicle unit parameters, such as the vehicle's location, vehicle's power transmission limit, battery capacity, current state of charge (SOC), and the like. The balance unit then generates the current power/energy availabilities from these vehicle units (based on the received vehicle unit parameters). This information can then be used by the grid to selectively charge/discharge the batteries of one or more vehicles for grid balancing purposes. The selection of vehicles and charge/discharge parameters (e.g., timing, power) depends on the vehicle unit parameters.

Clause 1. A method of balancing an electrical grid using a grid balancing unit, the electrical grid is defined by a grid boundary and comprising a grid controller, the method comprising: forming a system-vehicle communication channel between the grid balancing unit and at least one electric vehicle unit in a set of multiple electric vehicle units, wherein each electric vehicle unit comprises an electric vehicle comprising a battery and a user device associated with and communicatively coupled to the electric vehicle; receiving, at the grid balancing unit and through the system-vehicle communication channel, a set of vehicle unit parameters associated with each electric vehicle unit connected with the grid balancing unit through the system-vehicle communication channel and comprising at least one selected from the group consisting of a vehicle location within the grid boundary, a vehicle power transmission limit, a battery capacity, a current battery SOC, a minimum battery SOC, a maximum battery SOC, a start travel time, a start-travel minimum battery SOC, a power-supplying price, a power-receiving price, a minimum battery charge rate, and a maximum battery charge rate; generating, at the grid balancing unit, at least one of a current battery power availability and a current battery energy availability for the set of multiple electric vehicle units, based on the set of vehicle unit parameters; and transmitting to the grid controller, by the grid balancing unit, at least one of the current battery power availability and the current battery energy availability.

Clause 2. The method of clause 1, further comprising: receiving, at the grid balancing unit from the grid controller, a set of grid operating parameters associated with the electrical grid and comprising at least one selected from the group consisting of a current power demand, a current power supply, a current energy demand, and a current energy supply; generating, at the grid balancing unit, a system charge-discharge rate based on the set of grid operating parameters; and generating, at the grid balancing unit and based on the set of vehicle unit parameters and the system charge-discharge rate and transmitting from the grid balancing unit to each electric vehicle unit through the system-vehicle communication channel, a set of target battery operating parameters for each electric vehicle unit and comprising at least one selected from the group consisting of a target charge-discharge rate, a current battery power demand, a current battery energy demand, and a current battery power availability.

Clause 3. The method of clause 2, further comprising: receiving, at the grid balancing unit and through the system-vehicle communication channel from each electric vehicle unit connected with the grid balancing unit through the system-vehicle communication channel, a set of current battery operating parameters for each electric vehicle unit and comprising at least one selected from the group consisting of a current charge-discharge rate, and battery operating temperatures; and updating, at the grid balancing unit and based on the set of current battery operating parameters, the set of target battery operating parameters for each electric vehicle unit.

Clause 4. The method of clause 3, wherein (a) receiving the set of grid operating parameters, (b) generating the system charge-discharge rate, (c) generating and transmitting the set of target battery operating parameters for each electric vehicle unit, (d) receiving the set of vehicle unit parameters, and (e) updating the set of target battery operating parameters, are continuously repeated.

Clause 5. The method of clause 3, wherein (a) generating and transmitting the set of target battery operating parameters for each electric vehicle unit, (b) receiving the set of current battery operating parameters from each electric vehicle unit, and (c) updating the set of target battery operating parameters, are continuously repeated.

Clause 6. The method of clause 1, wherein the electric vehicle unit further comprises a bidirectional charging interface associated with and electrically coupled to the electric vehicle.

Clause 7. The method of clause 6, wherein the system-vehicle communication channel is communicatively coupled with at least one bidirectional charging interface, which is communicatively coupled with at least one electric vehicle unit.

Clause 8. The method of clause 7, wherein: the user device is physically separated from the electric vehicle and is communicatively coupled to each of the bidirectional charging interface, and the grid controller, and the user device is selected from the group consisting of a mobile telephone, a tablet computer, a laptop computer, a smart home device, and a smart power meter.

Clause 9. The method of clause 6, wherein the bidirectional charging interface is electrically coupled to the electrical grid and controls the electrical power supplied to the battery from the electrical grid and drawn from the battery to the electrical grid.

Clause 10. The method of clause 9, wherein: an electric vehicle comprises a bidirectional charging interface, the bidirectional charging interface comprises an inverter, and the bidirectional charging interface is reversibly connected to and exchanges alternating current with the electrical grid.

Clause 11. The method of clause 9, wherein the bidirectional charging interface is reversibly connected to and exchanges direct current with the battery.

Clause 12. The method of clause 6, wherein the bidirectional charging interface is fully controlled based on the set of target battery operating parameters received from the grid balancing unit.

Clause 13. The method of clause 2, wherein generating, at the grid balancing unit, a system charge-discharge rate comprises: identifying a power deficiency level based on the current power demand exceeding the current power supply, and selecting a first vehicle subset from the set of multiple electric vehicle units based on the current battery SOC exceeding the minimum battery SOC.

Clause 14. The method of clause 13, wherein selecting the first vehicle subset is further based on the greatest difference between the current battery SOC and the minimum battery SOC.

Clause 15. The method of clause 13, wherein selecting the first vehicle subset is further based on the current battery SOC and whether the vehicle location corresponds to a location within the grid boundary.

Clause 16. The method of clause 13, wherein selecting the first vehicle subset is further based on the vehicle power transmission limit, such that a combined value of the vehicle power transmission limit in the first vehicle subset exceeds the power deficiency level.

Clause 17. The method of clause 13, wherein selecting the first vehicle subset is further based on a difference between a current time and the start travel time exceeding a set timing threshold.

Clause 18. The method of clause 13, wherein selecting the first vehicle subset is further based on the highest value of the battery capacity.

Clause 19. The method of clause 13, wherein selecting the first vehicle subset is further based on the lowest value of the power-supplying price.

Clause 20. The method of clause 13, wherein generating, at the grid balancing unit and based on the set of vehicle unit parameters and the system charge-discharge rate and transmitting from the grid balancing unit to each electric vehicle unit through the system-vehicle communication channel, further comprises assigning the target charge-discharge rate to each electric vehicle based on the vehicle location.

Clause 21. The method of clause 2, wherein generating, at the grid balancing unit and based on the set of vehicle unit parameters and the system charge-discharge rate and transmitting from the grid balancing unit to each electric vehicle unit through the system-vehicle communication channel comprises: identifying a power excess level based on the current power supply exceeding the current power demand, and selecting a second vehicle subset from the set of multiple electric vehicle units based on the current battery SOC being less than the maximum battery SOC.

Clause 22. The method of clause 21, wherein selecting the second vehicle subset is further based on the vehicle power transmission limit, such that a combined value of the vehicle power transmission limit in the second vehicle subset exceeds the power excess level.

Clause 23. The method of clause 21, wherein selecting the second vehicle subset is further based on the highest value of the battery capacity.

Clause 24. The method of clause 1, wherein the system-vehicle communication channel communicatively couples the at least one electric vehicle unit with the grid balancing unit through the user device.

Clause 25. The method of clause 1, wherein a total battery capacity in the set of multiple electric vehicle units, represented by a sum of the battery capacity of each electric vehicle unit, is at least 10 MWh.

Clause 26. The method of clause 1, wherein the battery capacity of each electric vehicle unit is at least 10 kWh.

Clause 27. The method of clause 26, wherein the electric vehicle is an electric recreational vehicle.

Clause 28. The method of clause 1, wherein the vehicle power transmission limit of each electric vehicle is at least 100 kW.

Clause 29. A grid balancing unit comprising a processor and a computer-readable storage medium storing instructions that when executed by processor cause the grid balancing unit to perform a method of balancing an electrical grid defined by a grid boundary and comprising a grid controller, the method comprising: forming a system-vehicle communication channel between the grid balancing unit and at least one electric vehicle unit in a set of multiple electric vehicle units, wherein each electric vehicle unit comprises an electric vehicle comprising a battery and a user device associated with and communicatively coupled to the electric vehicle; receiving, at the grid balancing unit and through the system-vehicle communication channel, a set of vehicle unit parameters associated with each electric vehicle unit connected with the grid balancing unit through the system-vehicle communication channel and comprising at least one selected from the group consisting of a vehicle location within the grid boundary, a vehicle power transmission limit, a battery capacity, a current battery SOC, a minimum battery SOC, a maximum battery SOC, a start travel time, a start-travel minimum battery SOC, a power-supplying price, a power-receiving price, a minimum battery charge rate, and a maximum battery charge rate; generating, at the grid balancing unit, at least one of a current battery power availability and a current battery energy availability for the set of multiple electric vehicle units, based on the set of vehicle unit parameters; and transmitting to the grid controller, by the grid balancing unit, at least one of the current battery power availability and the current battery energy availability.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, and methods for balancing electrical grids with grid balancing units and a set of multiple electric vehicle units. These drawings in no way limit any changes in form and detail that may be made by one skilled in the art without departing from the spirit and scope of the disclosed implementations.

FIG. 1 is a schematic diagram of an electrical grid defined by a grid boundary 108 and comprising a grid controller, in accordance with some examples.

FIG. 2 is a block diagram of a set of multiple electric vehicle units connected to a grid balancing unit, which is in turn connected to an electrical grid, in accordance with some examples.

FIGS. 3A and 3B are block diagrams of an electric vehicle unit connected to a grid balancing unit, which is in turn connected to an electrical grid, in accordance with some examples.

FIG. 3C illustrates a block diagram of a computing system, which may be operable as a grid balancing unit, in accordance with some examples.

FIG. 4 is a process flowchart corresponding to a method for balancing an electrical grid using a grid balancing unit, in accordance with some examples.

### DETAILED DESCRIPTION

### Introduction

In vehicle-to-grid systems, electric vehicles that are connected to an electrical grid for charging also make available the electrical storage capacities of their batteries to the electrical grid for balancing grid demand. In these systems, grid-connected vehicles may provide stored power from their batteries to the grid during times of peak demand or may store excess electrical power from the grid during times of excess. The provision of stored power and the absorption of excess power by an electric vehicle, when connected to the grid, may be referred to collectively as grid-balancing. Electric vehicles are only able to provide grid-balancing when connected to the grid, i.e., not when they are being driven.

Electric vehicles are vehicles propelled by one or more electric motors. Electric vehicles in vehicle-to-grid systems may be passenger cars or vehicles with larger-capacity batteries, including trucks (e.g., box trucks, tow trucks, dump trucks, utility and service trucks, refrigerated trucks), ambulances/emergency vehicles, recreation vehicles (RVs), tow trucks, shuttle buses/passenger vans, and the like. For the purposes of this disclosure, an electric recreational vehicle is an electric vehicle that comprises living accommodations. Passenger cars can have batteries with a capacity of approximately 100 kWh. Typically, only a portion of the battery capacity, perhaps 25 %, is utilized for grid-balancing. This is so that the battery is not left in a nearly uncharged state when the car is disconnected from the grid for use. It is inconvenient if a grid-connected passenger car is discharged in order to support grid balancing when the vehicle is unexpectedly needed. Keeping the battery within a narrow range of charging while providing grid storage lessens the usefulness of each vehicle to the grid in leveling out need situations. If each car contributes 25 kWh to grid-balancing capacity, it will require 4,000 passenger cars to provide 100 MWh of grid storage.

It should be noted that, in practice, more than 4,000 passenger vehicles may be required to provide 100 MWh of grid storage at any time because passenger vehicles connect and disconnect from an electrical grid frequently during the day and week. In addition, many passenger vehicles charge mostly at night while most of the driving is done during the day. The time that any one passenger car is connected to the grid may not coincide with the times when grid balancing is required and may not be easily predictable.

Commercial vehicles, such as trucks and buses, have larger capacity batteries and, therefore, are able to provide more storage capacity for a vehicle-to-grid system. Compared to passenger cars, their use is more scheduled and predictable. However, like passenger cars, their time spent connected to the grid is typically only a portion of the day, because they are often disconnected from the grid for daily use.

Another concern with vehicle-to-grid systems employing all-electric vehicles is battery health. Charging and discharging cycles affect the health of the battery, and each battery has a limited usage lifetime that is decreased by each charge/discharge cycle. From the perspective of the battery lifetime, storing power and drawing power from a grid-connected battery is effectively a partial charge/discharge cycle. This can decrease the lifetime of the battery relative to the lifetime use of the vehicle. It should be noted that approximately 1/3 of the cost of an electric vehicle may be attributed to the cost of the battery system. Decreasing the lifetime of the battery by engaging the battery in grid-balancing may be a concern for owners of electric passenger cars, as well as for the owners of fleet vehicles like trucks and buses. In addition, extended periods at full charge can affect battery health and decrease battery lifetime. Using the vehicle for grid balancing can serve to reduce the frequency at which batteries are at full charge for extended periods.

While electric vehicle batteries may be used to contribute their storage capacity to help level demand in the connected electrical grid, the currently used electric vehicles and methods for managing batteries are not sufficient. Smaller electric vehicles like passenger cars each provide a limited amount of battery capacity to the electrical grid. While there are larger vehicles with larger batteries and more predictable usage schedules, such as trucks and buses, the times of day they are available for providing grid leveling may not coincide with the times of peak and valley of demand on the grid. Additionally, trucks and buses are typically used daily, and the time they are connected to the grid approaches the time necessary to charge their batteries to prepare them for their next use. This limits the amount of time they are connected to the grid and is available to provide grid-balancing battery capacity.

In addition, as electric vehicles are connected and disconnected and their charging and discharging parameters change, an interface is needed to coordinate the charging and discharging of vehicle batteries with the power demand and supply of connected electrical grids.

What is needed are new electric recreational vehicles and grid-balancing units to provide grid-balancing and methods to balance electrical grids using a grid-balancing unit.

### Examples of Electrical Grids

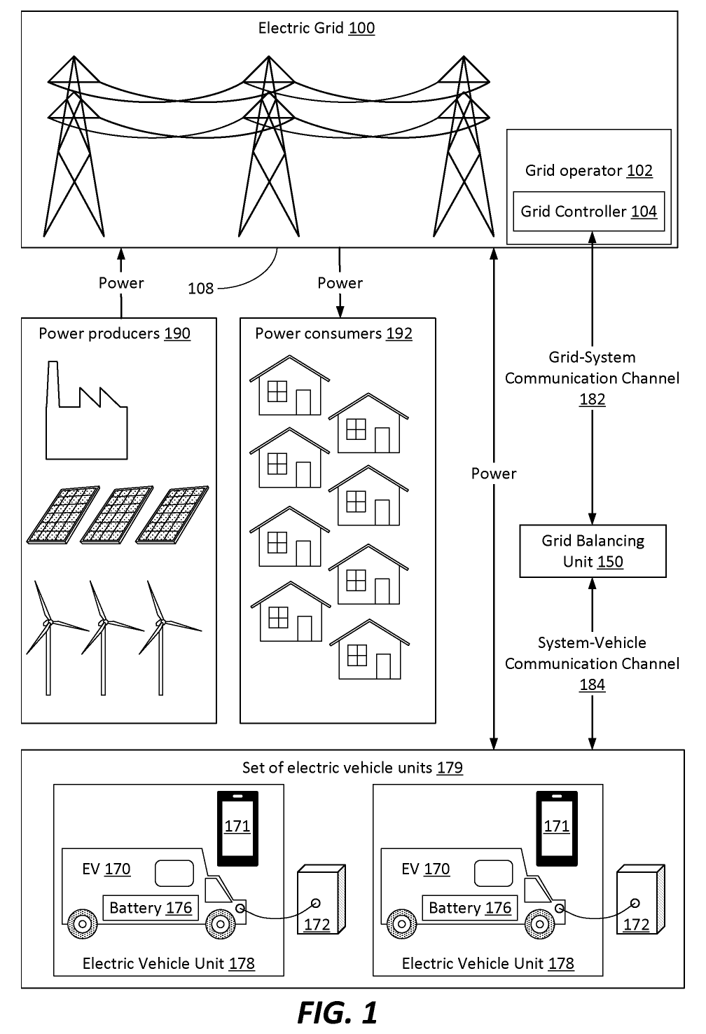

FIG. 1 is a schematic diagram of an electrical grid 100 defined by a grid boundary 108 and comprising a grid controller 104, in accordance with some examples. In some examples, as shown in FIG. 1, the electrical grid 100 further comprises a grid operator 102, which comprises the grid controller 104. As shown in FIG. 1, power producers 190 are connected to the electrical grid 100. The power producers 190 generate electrical power and supply it to the electrical grid 100. As also shown in FIG. 1, power consumers 192 are electrically connected with the electrical grid 100. The connections between the electrical grid 100 and either or both of the power producers 190 and power consumers 192 may comprise electrical couplings, communicative couplings, or both electrical and communicative couplings. The electrical grid 100 receives electrical power from the power producers 190 and transmits electrical power to the power consumers 192.

The grid controller 104 controls the operation of the electrical grid 100. In some examples, the electrical grid 100 further comprises a grid operator 102. The grid operator 102 is an authority that operates the electrical grid 100. For example, the grid operator 102 may be a utility company, a municipal authority, or a unit of a utility company or municipal authority.

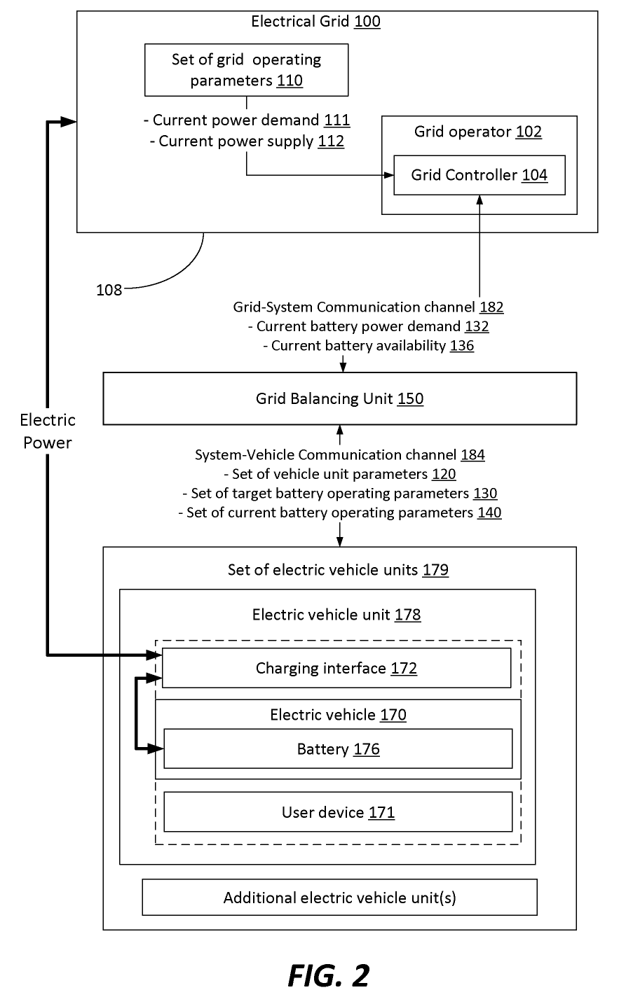

FIG. 2 is a block diagram of a set of electric vehicle units 179 connected to a grid balancing unit 150, which is in turn connected to an electrical grid 100, in accordance with some examples. In the example shown in FIG. 2, the grid balancing unit 150 is communicatively coupled with the grid controller 104 by a grid-system communication channel 182. The set of multiple electric vehicle units 179 and the grid-system communication channel 182 will be described in more detail below.

Returning to FIG. 1, the grid boundary 108 is a boundary within which electrical equipment may be connected with the electrical grid 100. Political boundaries or geographic features do not necessarily define the grid boundary 108. Instead, various components of the electrical grid may define the grid boundary 108. For example, the grid boundary 108 may be defined by the availability of electrical transmission lines to which electrical equipment may be connected, and thereby be connected with the electrical grid 100. In other examples, the grid boundary 108 may be defined as an area served by a specific component or components of electrical transmission equipment operated by the electrical grid 100, for example, a substation or a set of transformers. In some examples, the grid boundary 108 corresponds with the area served by the electrical grid 100. In some examples, the grid boundary 108 corresponds with the area within which electrical equipment is communicatively coupled with the grid operator 102 and/or the grid controller 104. In some examples, power producers 190 electrically coupled with the electrical grid 100 are located within the grid boundary 108. In other examples, some power producers 190 are located outside of the grid boundary 108. In some examples, power consumers 192 are located within the grid boundary 108. In other examples, some power consumers 192 are located outside of the grid boundary 108.

As shown in FIG. 2, in some examples, the electrical grid 100 comprises a set of grid operating parameters 110. The set of grid operating parameters 110 may comprise a current power demand 111. The current power demand 111 is the demand for electrical power from the electrical grid 100 by the power consumers 192. In the same or other examples, the set of grid operating parameters 110 may comprise a current power supply 112. The current power supply 112 is the supply of electrical power to the electrical grid 100 from the power producers 190. In some examples, the set of grid operating parameters 110 is communicated to the grid controller 104.

Also, as shown in FIG. 2, in some examples, the grid balancing unit 150 is communicatively coupled with the grid controller 104 via the grid-system communication channel 182. The grid-system communication channel 182 is a bi-directional communication channel, allowing the grid controller 104 to transmit information to the grid balancing unit 150 and the grid balancing unit 150 to transmit information to the grid controller 104.

### Examples of Electric Vehicles Connected to Electrical Grids

Returning to FIG. 1, a system-vehicle communication channel 184 connects the grid balancing unit 150 with at least one electric vehicle unit 178 in a set of multiple electric vehicle units 179. Each electric vehicle unit 178 comprises a user device 171 and an electric vehicle 170 comprising a battery 176. The user device 171 is associated with and communicatively coupled with the electric vehicle 170.

In some examples, the battery 176 has a capacity of greater than 30 kWh or, more specifically, greater than 50, 100, 200, 250, 275, 300, or even 500 kWh. Battery capacity may be calculated as the product of the electrical current that a fully charged battery can provide to a load, the voltage that the battery provides the current at, and the length of time that it can provide that current at that voltage. For example, a battery that can provide a current of 100 amps (A) at 100 volts (V) for 10 hours (h) is calculated as 100 A x 100 V x 10 h and equals 100,000 Wh or 100 kWh. Various types of battery 176 are within the scope, e.g., low voltage battery packs, high voltage battery packs, single or multiple packs, single cell or numerous cells in parallel or series, etc.

In some examples, the battery 176, or more specifically, the battery management system (BMS) of the battery 176 is configured to measure a current battery state of charge (SOC) 124. The current battery SOC 124 represents the amount of electrical charge stored in the battery 176 at the time the input is measured, relative to the capacity of the battery 176. The minimum value for the current battery SOC 124 is 0 %, representing a state of charge when no electrical charge is stored in the battery 176. In some examples, the maximum value for the current battery SOC 124 may be 100 %, representing a state of charge when the amount of electrical charge stored in the battery 176 equals the design capacity of the battery 176. In other examples, the maximum value may be 105 %, 110 %, or even 125 %, indicating states of charge in which the amount of electrical charge stored in the battery 176 exceeds the design capacity of the battery 176. The current battery SOC 124 may be calculated taking one or more battery charge-related values into account, e.g., the temperature of the battery 176, the voltage measured for the battery 176 and/or for individual cells of the battery 176, and the battery capacity. The current battery SOC 124 may be calculated by measuring the charge passed during charging and discharging, relative to the battery capacity.

In some examples, the battery 176 is communicatively coupled to the system-vehicle communication channel 184, e.g., to communicate a vehicle power transmission limit 122 to the grid balancing unit 150 via the system-vehicle communication channel 184.

In some examples, the battery 176, or more specifically, the battery management system (BMS) of the battery 176, is further configured to measure a state of health (SOH) input for the battery 176. The SOH input may be calculated taking one or more battery health-related values into account, e.g., the number of charge/discharge cycles experienced by the battery, the battery capacity, the open circuit voltage (OCV), the voltage under load, the internal resistance, the ability of the battery to receive charge, the battery age, the battery temperature, and the total electrical charge charged or discharged by the battery.

In some examples, the user device 171 is configured to record a vehicle location 121. In some examples, the user device 171 is configured to record a minimum battery SOC 125a. In some examples, the user device 171 is configured to record a maximum battery SOC 125b. In some examples, the user device 171 is configured to record a start travel time 126a. In some examples, the user device 171 is configured to record a start-travel minimum battery SOC 126b. In some examples, the user device 171 is configured to record a power-supplying price 127a. In some examples, the user device 171 is configured to record a power-receiving price 127b. In some examples, the user device 171 is configured to record a minimum battery charge rate 128a. In some examples, the user device 171 is configured to record a maximum battery charge rate 128b.

In some examples, the user device 171 may be incorporated into the electric vehicle 170. For example, the user device 171 may be incorporated into the battery 176, a battery management system (BMS) of the battery 176, a charging interface of the electric vehicle 170, or located in the cab of the electric vehicle 170. For example, the user device 171 may be included in a dashboard control or an infotainment system installed in the cab of the electric vehicle 170. In some other examples, the user device 171 is physically separate from the electric vehicle 170, as shown in FIG. 1. For example, the user device 171 may be a mobile telephone, a tablet computer, a laptop computer, a smart home device, or a smart power meter. In some other examples, the user device 171 may be included in a bidirectional charging interface 172.

In some examples, a bidirectional charging interface 172 is electrically coupled with the electrical grid 100 and controls electrical power supplied to the battery 176 from the electrical grid 100 and drawn from the battery 176 to the electrical grid 100. In some examples, the set of multiple electric vehicle units 179 comprises at least one bidirectional charging interface 172. In some examples, the set of multiple electric vehicle units 179 comprises at least one bidirectional charging interface 172 for each electric vehicle unit 178 comprising an electric vehicle 170 connected to the electrical grid 100.

In some examples, the system-vehicle communication channel 184 is communicatively coupled with at least one bidirectional charging interface 172, thereby communicatively coupling the bidirectional charging interface 172 with the grid balancing unit 150. In some of these examples, the bidirectional charging interface 172 may also be communicatively coupled with at least one electric vehicle unit 178. In some further examples, the bidirectional charging interface 172 is fully controlled by the grid balancing unit 150.

In some examples, the bidirectional charging interface 172 is configured to transmit and receive alternating current (AC). In such examples, the bidirectional charging interface 172 is configured to convert alternating current supplied by the electrical grid 100 into direct current that can charge the battery 176. In the same or other examples, the bidirectional charging interface 172 is configured to convert direct current supplied by the battery 176 to alternating current that may be supplied to the electrical grid 100.

In some examples, the bidirectional charging interface 172 is reversibly coupled with the electric vehicle 170 with a direct current (DC) connection. In other words, the electric vehicle 170 can be connected to a DC charging system, which is, in turn, connected to the electrical grid 100.

In some other examples, the electric vehicle 170 comprises the bidirectional charging interface 172. In these examples, the bidirectional charging interface is reversibly connected to and exchanges alternating current with the electrical grid 100 via an alternating current connection. In these examples, the bidirectional charging interface 172 is connected to, and exchanges direct current with the battery 176.

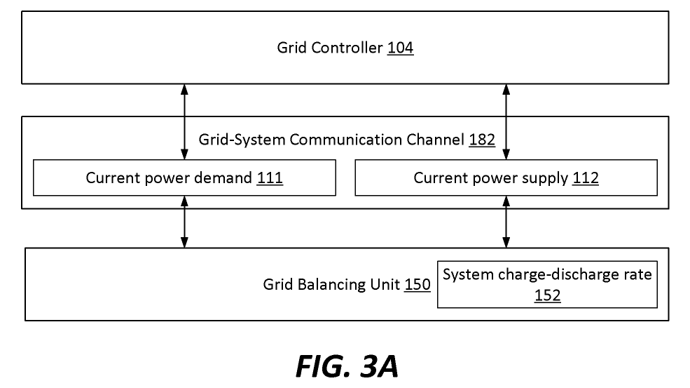

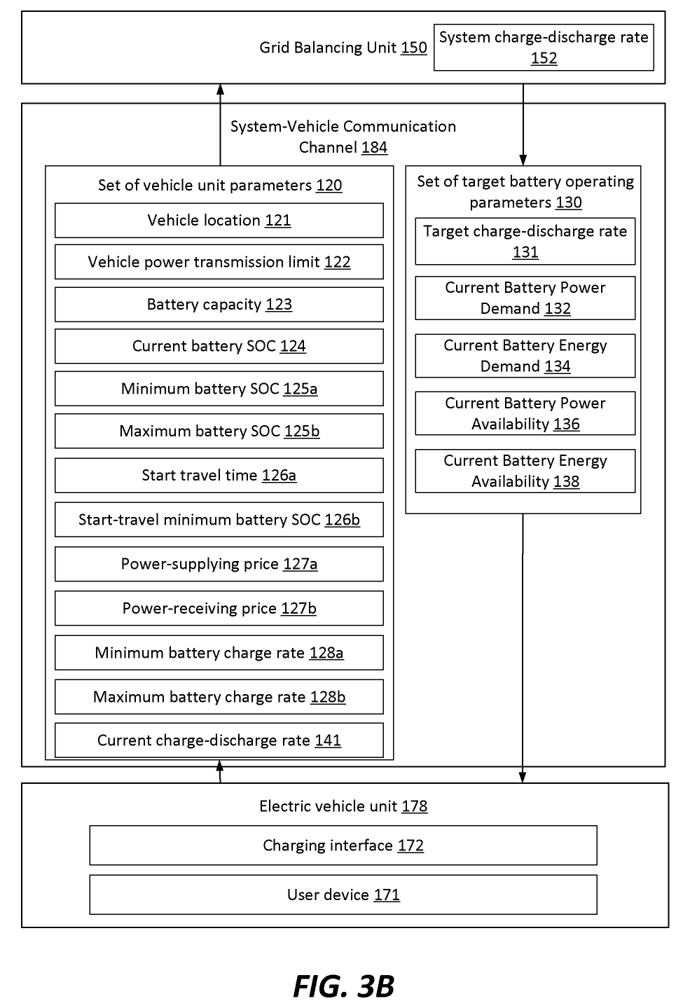

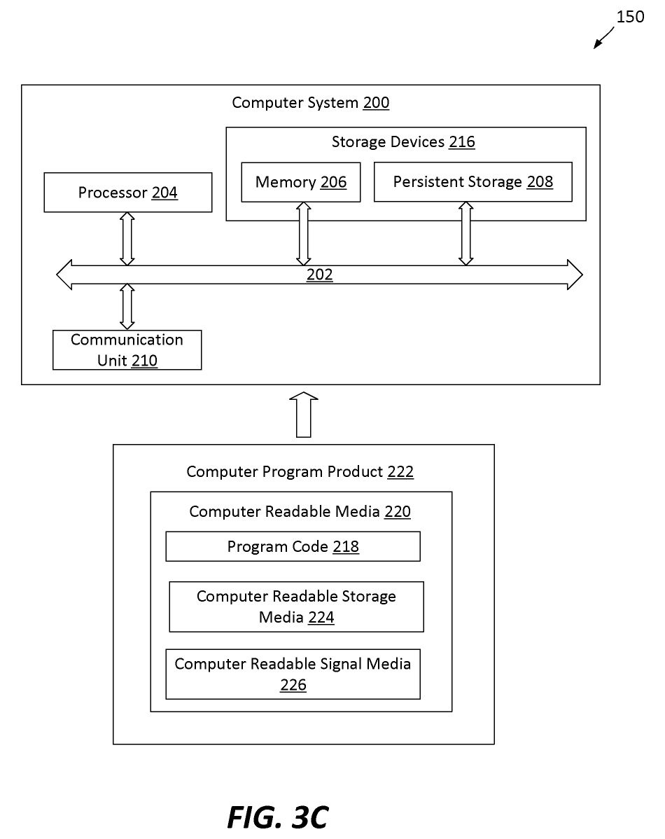

In some examples, as shown in FIG. 3B, the electric vehicle unit 178 comprises the bidirectional charging interface 172. In some other examples, the set of multiple electric vehicle units 179 comprises more than one bidirectional charging interface 172. In these examples, the bidirectional charging interface 172 may be reversibly coupled with the electric vehicle 170, thereby electrically connecting the bidirectional charging interface 172 with the battery 176 of the connected electric vehicle 170.

In some examples, a bidirectional charging interface 172 is coupled with the electric vehicle 170 and the power connection to the electrical grid 100. In these examples, the bidirectional charging interface 172 is configured to provide an interface between the electric vehicle 170 and the electrical grid 100 to transmit electrical charge to or from the electric vehicle 170. In some further examples, each electric vehicle unit 178 of the set of multiple electric vehicle units 179 is coupled with a bidirectional charging interface 172 when it is electrically coupled with the electrical grid 100. Each electric vehicle unit 178 may be communicatively coupled with the grid balancing unit 150 regardless of whether it is coupled with a bidirectional charging interface 172 at a given time.

In some examples, the electric vehicle 170 is connected to the electrical grid 100 at a location where the electric vehicle 170 is stored when not in use. This location may be, for example, a residence. In such an example, the electric vehicle 170 is stored at some distance from other electric vehicles 170 connected to the same electrical grid 100 and provides grid-balancing battery capacity distributed within the geographic area served by the electrical grid 100, or within the grid boundary 108, at a distance from other electric vehicles 170. In other examples, the electric vehicle 170 is one of several stored together in one storage location. In such examples, the grid-balancing capacity is not as distributed geographically, but the installation of electrical equipment to connect multiple vehicles to the set of grid operating parameters 110 in one location may provide advantages of scale. In some examples, the location where the electric vehicle 170 is connected to the electrical grid 100 relative to one or more of the power producers 190 and/or one or more of the power consumers 192 influences whether the electric vehicle 170 provides grid-balancing battery capacity. An electric vehicle 170 located closer to the power producers 190 and/or the power consumers 192 may minimize transformation losses within the system electrical grid 100.

In some examples, the electric vehicle 170 may be communicatively coupled with the grid balancing unit 150 via the bidirectional charging interface 172. In some further examples, the bidirectional charging interface 172 may be the user device 171. In some other further examples, the bidirectional charging interface 172 may comprise the user device 171.

### Computer System Examples

FIG. 3C illustrates a block diagram of a computing system, which may be operable as a grid balancing unit 150, in accordance with some examples. A similar computing system may be used for a grid controller 104 and/or a user device 171. In various examples, computer system 200 includes communications framework 202 (e.g., a bus), which provides communications between processor unit 204, memory 206, persistent storage 208, and communications unit 210. Communications unit 210 provides for communications with other systems, such as forming grid-system communication channels 182 and system-vehicle communication channel 184. In these illustrative examples, communications unit 210 may be a network interface card, a modem, or other suitable communications device/interface.

Processor unit 204 serves to execute instructions for software that may be loaded into memory 206. Processor unit 204 may be a number of processors, a multi-processor core, or some other type of processor, depending on the particular implementation.

Memory 206 and persistent storage 208 are examples of storage devices 216, e.g., computer-readable storage components. Memory 206 may be a random-access memory (RAM) or any other suitable volatile or non-volatile storage device. Persistent storage 208 may take various forms, e.g., a hard drive, a flash memory, or some combination of the above. Instructions for the operating system, applications, and/or programs may be located in storage devices 216. The techniques of the different examples may be performed by processor unit 204 using computer-implemented instructions, which may be located in a memory, such as memory 206. For example, these instructions may include various operations of method 400 described below, such as forming a system-vehicle communication channel 184, receiving a set of vehicle unit parameters 120, generating at least one of a current battery power availability 136, and transmitting at least one of the current battery power availability 136 and the current battery energy availability 138.

These instructions are referred to as program code, computer-usable program code, or computer-readable program code. The program code in the different examples may be embodied in different physical or computer-readable storage media, such as memory 206 or persistent storage 208. Program code 218 is located in a functional form on computer-readable media 220 that may be loaded onto or transferred to computer system 200 for execution by processor unit 204. Program code 218 and computer-readable media 220 form computer program product 222 in these illustrative examples. In one example, computer-readable media 220 may be computer-readable storage media 224 or computer-readable signal media 226.

In these illustrative examples, computer-readable storage media 224 is a physical or tangible storage device used to store program code 218 rather than a medium that propagates or transmits program code 218.

Alternatively, program code 218 may be transferred to computer system 200 using computer-readable signal media 226. Computer-readable signal media 226 may be, for example, a propagated data signal containing program code 218. For example, computer-readable signal media 226 may be an electromagnetic signal, an optical signal, and/or any other suitable type of signal. These signals may be transmitted over communications links, such as wireless communications links, optical fiber cables, coaxial cables, a wire, and/or any other suitable type of communications link.

### Examples of Methods of Grid Balancing Using Electric Vehicles

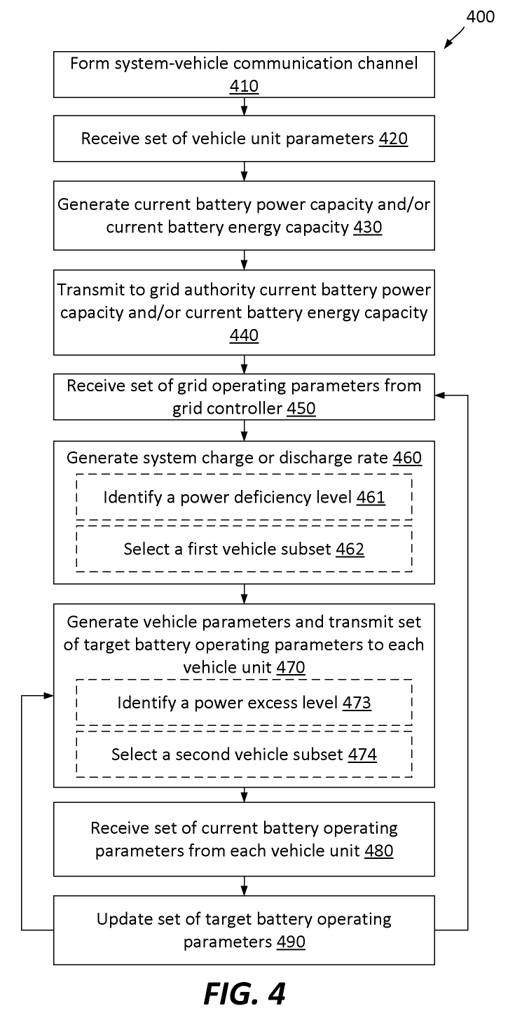

FIG. 4 is a process flowchart corresponding to method 400 for balancing an electrical grid 100 using a grid balancing unit 150, the electrical grid 100 defined by a grid boundary 108 and comprising a grid controller 104, in accordance with some examples. Various examples of electrical grids 100, grid balancing units 150, grid controllers 104, and grid boundaries 108 are described above.

FIGS. 3A and 3B are block diagrams of an electric vehicle unit 178 connected to a grid balancing unit 150, which is in turn connected to an electrical grid 100, forming a data connection layer with the electrical grid 100, in accordance with some examples. Specifically, FIG. 3A illustrates details of a grid-system communication channel 182 connecting an electrical grid 100 and a grid balancing unit 150, in accordance with some examples. FIG. 3B illustrates details of a system-vehicle communication channel 184 connecting a set of multiple electric vehicle units 179 and the grid balancing unit 150.

Returning to FIG. 4, in some examples, the method 400 commences with (block 410) forming a system-vehicle communication channel 184 between the grid balancing unit 150 and at least one electric vehicle unit 178 in a set of multiple electric vehicle units 179. In these examples, each electric vehicle unit 178 comprises an electric vehicle 170 comprising a battery 176. In some examples, the electric vehicle unit 178 also comprises a user device 171, associated with and communicatively coupled to the electric vehicle 170. Various examples of electric vehicles 170, batteries 176, and user devices 171 are described above. The system-vehicle communication channel 184 is a bidirectional data connection that enables data communication between the grid balancing unit 150 and at least one electric vehicle unit 178. In some examples, the system-vehicle communication channel 184 is a bidirectional data connection that enables data connection with each electric vehicle unit 178 of the set of multiple electric vehicle units 179. In some other examples, the system-vehicle communication channel 184 enables data communication between the grid balancing unit 150 and a subset of electric vehicle units 178 of the set of multiple electric vehicle units 179. For example, the system-vehicle communication channel 184 may enable data communication between the grid balancing unit 150 and one electric vehicle unit 178, more than one, more than two, more than 5, more than 10, more than 25, more than 50, more than 100, more than 200, more than 500, or even more than 1000 electric vehicle units 178. In some examples, the system-vehicle communication channel 184 is a wireless data connection. In some other examples, the system-vehicle communication channel 184 is a wired data connection. In yet some other examples, the system-vehicle communication channel 184 is a wired data connection that connects with some electric vehicle units 178, and a wireless data connection that connects with some other electric vehicle units 178.

In some examples, the method 400 proceeds with (block 420) receiving, at the grid balancing unit 150 and through the system-vehicle communication channel 184, a set of vehicle unit parameters 120 associated with each electric vehicle unit 178 connected with the grid balancing unit 150. The connected electric vehicle units 178 are connected with the grid balancing unit 150 through the system-vehicle communication channel 184. Details of the set of vehicle unit parameters 120 that may be received by the grid balancing unit 150 via the system-vehicle communication channel 184 connecting the grid balancing unit 150 and at least one electric vehicle unit 178 are illustrated in FIG. 3B. The set of vehicle unit parameters 120 comprises at least one selected from the group consisting of a vehicle location 121 within the grid boundary 108, a vehicle power transmission limit 122, a battery capacity 123, a current battery SOC 124, a minimum battery SOC 125a, a maximum battery SOC 125b, a start travel time 126a, a start-travel minimum battery SOC 126b, a power-supplying price 127a, a power-receiving price 127b, a minimum battery charge rate 128a, and a maximum battery charge rate 128b. In some examples, the user device 171 is configured to record one or more of the minimum battery SOC 125a, a maximum battery SOC 125b, a start travel time 126a, a start-travel minimum battery SOC 126b, a power-supplying price 127a, a power-receiving price 127b, a minimum battery charge rate 128a, and a maximum battery charge rate 128b. In some further examples, one or more of the set of vehicle unit parameters 120 may be recorded from user input to the user device 171.

The vehicle location 121 may be the location of the electric vehicle unit 178 relative to a map of the earth or a map of political boundaries. The vehicle location 121 may be the location of the electric vehicle unit 178 relative to the grid boundary 108. In some examples, the user device 171 is configured to record the vehicle location 121. In some examples, the user device 171 comprises positioning capabilities and measures the vehicle location 121 by, for example, the global positioning system (GPS).

The vehicle power transmission limit 122 represents the maximum rate that the electric vehicle 170 can receive or transmit electrical power when connected with the electrical grid 100. The vehicle power transmission limit 122 may be expressed as a unitless factor. For example, when the electric vehicle 170 is disconnected from the electrical grid 100, the factor may be equal to 0. When the electric vehicle 170 is charging or discharging at its maximum design charge or discharge rate, the factor may be equal to 100. The battery capacity 123, as described above, represents the product of the electrical current that a fully charged battery can provide to a load, the voltage that the battery provides the current at, and the length of time that it can provide that current at that voltage. In some examples, the vehicle power transmission limit is at least 100 kW. For example, the vehicle power transmission limit may be greater than 25 kW, greater than 50 kW, greater than 150 kW, greater than 200 kW, or even greater than 300 kW.

The current battery SOC 124 represents the state of charge of the battery 176 at a given time. A minimum battery SOC 125a may be a state of charge value/level that a battery 176 does not go below during discharging (e.g., to prevent damage to the battery). A maximum battery SOC 125b may be a state of charge value/level that a battery 176 does not go above during charging. For example, the user and/or the battery manufacturer may select a minimum battery SOC 125a and a maximum battery SOC 125b. In some examples, the minimum battery SOC 125a and/or the maximum battery SOC 125b may be set by the grid balancing unit 150 (e.g., in response to specific power and/or energy demands from the grid operator 102). The combination of the minimum battery SOC 125a and the maximum battery SOC 125b may serve as a range of SOC that the battery 176 will be maintained within during charge and discharge cycles while the electric vehicle unit 178 is connected with the grid balancing unit 150.

A start travel time 126a represents a time and date in the future. The start travel time 126a may be an input provided by the user of the electric vehicle 170 representing the date on which it will next be disconnected from the electrical grid 100 for use. For example, a start travel time 126a may be selected for a time and date in the future when a user plans to drive the electric vehicle 170, or disconnect the electric vehicle unit 178 from the grid balancing unit 150. A start-travel minimum battery SOC 126b represents a state of charge value. For example, a start-travel minimum battery SOC 126b may be a minimum state of charge that a user selects a battery 176 to be at or above at a time in the future, which may be the start travel time 126a. The start-travel minimum battery SOC 126b may be a value provided by the user of the electric vehicle 170 representing the desired battery state of charge by the start travel time 126a. For example, start-travel minimum battery SOC 126b may be 75 % for one anticipated driving distance and may be 95 % for another, longer anticipated driving distance. In some examples, the start travel time 126a and the start-travel minimum battery SOC 126b are received from the user device 171.

A power-supplying price 127a and a power-receiving price 127b represent monetary values for units of electrical energy. Power-supplying price 127a and power-receiving price 127b may be expressed, for example, as a price per kWh. For example, a user may select a power-supplying price 127a of $0.05/kWh and a power-receiving price 127b of $0.03/kWh. In this example, the selection may be interpreted by the grid balancing unit 150 as a price of $0.05/kWh below which the battery will not provide power to the electrical grid 100 and a price of $0.03/kWh above which the battery will not receive power from the electrical grid 100. The grid controller 104 or the grid operator 102 may set prices for the transfer of electrical power, and these prices may vary, for example, with time of day, day of the week, and the set of grid operating parameters 110. Selecting a power-supplying price 127a and a power-receiving price 127b allows a user to determine pricing conditions during which the electric vehicle unit 178 will participate in grid balancing.

A minimum battery charge rate 128a and a maximum battery charge rate 128b represent the charging rates of the battery 176. Minimum battery charge rate 128a and maximum battery charge rate 128b may be expressed, for example, in units of Coulombs per unit time or kilowatts. For example, a user may select a minimum battery charge rate 128a of 5 kilowatts and a maximum battery charge rate 128b of 100 kilowatts. This selection may be interpreted by the grid balancing unit 150 as a range of charging rates for the battery 176 of between 5 and 100 kilowatts. It may be desirable to communicate a minimum battery charge rate 128a and a maximum battery charge rate 128b because some electric vehicle 170 may have different battery charging specifications.

Returning to FIG. 4, in some examples, the method 400 proceeds with (block 430) generating, at the grid balancing unit 150, at least one of a current battery power availability 136 and a current battery energy availability 138 for the set of multiple electric vehicle units 179. The current battery power availability 136 and/or the current battery energy availability 138 are generated based on the set of vehicle unit parameters. The current battery power availability 136 represents the total power capacity available to the electrical grid 100 by the batteries 176 in the set of multiple electric vehicle units 179 connected with the grid balancing unit 150 (and, e.g., positioned within a set grid boundary 108). For example, the vehicle power transmission limit 122 may be summed up for all "available" vehicles. The vehicle's availability to provide power may be determined based on one or more of the current battery SOC 124, the minimum battery SOC 125a/the maximum battery SOC 125b (depending on the charge/discharge), start travel time 126a (as well as the current time and ability to recharge the vehicle before the start travel time 126a), a start-travel minimum battery SOC 126b.

Overall, the current battery power availability 136 may represent a capacity to receive an amount of power from the electrical grid 100 or a capacity to provide an amount of power to the electrical grid 100. The current battery energy availability 138 represents the total energy capacity available to the electrical grid 100 by the batteries 176 in the set of multiple electric vehicle units 179 connected with the grid balancing unit 150. Similar to the current battery power availability 136, the current battery energy availability 138 may represent amounts of energy that can be provided to the electrical grid 100 or received from the electrical grid 100 by the set of multiple electric vehicle units 179.

In some examples, the method 400 proceeds with (block 440) transmitting to the grid controller 104, by the grid balancing unit 150, at least one of the current battery power availability 136 and the current battery energy availability 138.

In some examples, the method 400 proceeds with (block 450) receiving, at the grid balancing unit 150 from the grid controller 104, a set of grid operating parameters 110. The set of grid operating parameters 110 is associated with the electrical grid 100 and comprises at least one selected from the group consisting of a current power demand 111, a current power supply 112, a current energy demand, and a current energy supply. A current power demand 111 represents the demand for power at a given time by the power consumers 192 connected with the electrical grid 100. A current power supply 112 represents the supply of power at a given time from the power producers 190 connected with the electrical grid 100. If the current power demand 111 is greater than the current power supply 112, there is a scarcity of electrical power in the electrical grid 100. If the current power demand 111 is smaller than the current power supply 112, there is an excess of electrical power in the electrical grid 100. A current energy demand represents the demand for energy at a given time by the power consumers 192 connected with the electrical grid 100. A current energy supply represents the supply of energy at a given time from the power producers 190 connected with the electrical grid 100. If the current energy demand is greater than the current energy supply, there is a scarcity of electrical energy in the electrical grid 100. If the current energy demand is smaller than the current energy supply, there is an excess of electrical energy in the electrical grid 100.

In some examples, the method 400 proceeds with (block 460) generating, at the grid balancing unit 150, a system charge-discharge rate 152 based on the set of grid operating parameters 110. The system charge-discharge rate 152 represents a rate for the transfer of electrical charge between the electrical grid 100 and the set of multiple electric vehicle units 179. The system charge-discharge rate 152 may be calculated based on the set of grid operating parameters 110 such that the transfer of electrical charge between the electrical grid 100 and the set of multiple electric vehicle units 179 will result in grid balancing of the electrical grid 100. The system charge-discharge rate 152 may be expressed in units of electrical charge per unit time, power, or energy. For example, if the set of grid operating parameters 110 is such that the current power demand 111 is greater than the current power supply 112, the grid balancing unit 150 may generate a system charge-discharge rate 152 that represents the transfer of electrical power from the set of multiple electric vehicle units 179 to the electrical grid 100.

In some examples, the method 400 proceeds with (block 470) generating, at the grid balancing unit 150, and transmitting from the grid balancing unit 150 to each electric vehicle unit 178 a set of target battery operating parameters 130 for each electric vehicle unit 178. The set of target battery operating parameters 130 is based on the set of vehicle unit parameters 120 and the system charge-discharge rate 152. The grid balancing unit 150 transmits the set of target battery operating parameters 130 through the system-vehicle communication channel 184. The set of target battery operating parameters 130 comprises at least one selected from the group consisting of a target charge-discharge rate 131, current battery power demand 132, current battery energy demand 134, current battery power availability 136, and current battery energy availability 138.

The target charge-discharge rate 131 describes the rate and direction of power transfer between the battery 176 and the electrical grid 100. The current battery power demand 132 represents the amount of power transferred to the battery 176 of the electric vehicle unit 178 from the electrical grid 100. The current battery energy demand 134 represents the amount of power transferred from the electric vehicle unit 178 of the electric vehicle unit 178 to the electrical grid 100.

In some examples, the target charge-discharge rate 131 describes the rate of power transfer from the electrical grid 100 to the battery 176 such that the current battery SOC 124 is equal to the start-travel minimum battery SOC 126b at start travel time 126a. In some examples, the target charge-discharge rate 131 describes a combination of charging and discharging power transfers. In some examples, the target charge-discharge rate 131 is such that the difference between the current date and the start travel time 126a is less than or equal to a time to charge. In these examples, the time to charge is calculated as the difference between the start-travel minimum battery SOC 126b and the current battery SOC 124 divided by the vehicle power transmission limit 122. For example, if the start-travel minimum battery SOC 126b is 90 % and the current battery SOC 124 is 75 %, the difference is 15 %. If the vehicle power transmission limit 122 is 5 % per hour, the time to charge is calculated to be 3 hours. The time to charge can also be calculated with state of charge values in units of kW and the maximum charge rate in units of kWh. In some examples, the time to charge is equal to the battery capacity in kWh divided by the power rating of the bidirectional charging interface 172. In some examples, the time to charge is 24 hours.

In some examples, the grid balancing unit 150 may identify a power deficiency level based on the current power demand 111 exceeding the current power supply 112. In some other examples, the grid balancing unit 150 may identify a power excess level based on the current power supply 112 exceeding the current power demand 111.

In some examples, when the difference between the current date and the start travel time 126a is less than or equal to the time to charge and the current battery SOC 124 is less than the maximum battery SOC 125b, and grid balancing unit 150 identifies a power excess level, the grid balancing unit 150 generates the target charge-discharge rate 131 such that the state of charge will be equal to the start-travel minimum battery SOC 126b by the start travel time 126a. In some examples, the maximum battery SOC 125b may be an input provided by the user via the user device 171. In some examples, the maximum battery SOC 125b may be 70 %, 75 %, 85 %, 95 %, 100 %, or even 105 %.

In some examples, when the difference between the current date and start travel time 126a is greater than the time to charge, the current battery SOC 124 is greater than the minimum battery SOC 125a, and the grid balancing unit 150 identifies a power deficiency level, the grid balancing unit 150 generates the target charge-discharge rate 131 such that the battery 176 is discharged to the electrical grid 100. In some examples, the minimum battery SOC 125a may be an input provided by the user via the user device 171. In some examples, the minimum battery SOC 125a may be 50 %, 40 %, 25 %, 5 %, 1 %, or even 0 %.

In some examples, when the difference between the current date and start travel time 126a is not less than or equal to the time to charge, the current battery SOC 124 is not less than the maximum battery SOC 125b, and the grid balancing unit 150 identifies a power excess level, the grid balancing unit 150 generates the target charge-discharge rate 131 such that the current battery SOC 124 is unchanged.

In some examples, when the difference between the current date and the start travel time 126a is not less than or equal to the time to charge, the grid balancing unit 150 generates the target charge-discharge rate 131 such that the current battery SOC 124 remains within a target idle state of charge range. In these examples, the target idle state of charge range is a set state of charge range. For example, the target idle state of charge range may be 50 %-75 %, 45 %-80 %, or even 30 %-90 %. In some further examples, the target idle state of the charge range is an input recorded by the user device 171.

In some examples, when the state of health (SOH) is less than or equal to a target battery state of health, the grid balancing unit 150 generates the target charge-discharge rate 131 such that the battery 176 is charged and discharged relatively less frequently than it would be if the state of health (SOH) was greater. For example, limiting the number of charge/discharge cycles of battery 176 can be prioritized over grid-balancing to reduce the number of cycles experienced by battery 176. In some further examples, the target battery's state of health (SOH) is recorded by the user device 171.

In some examples, the grid balancing unit 150, instructs the bidirectional charging interface 172 to manage charge transfer between the electrical grid 100 and the battery 176 based on the set of target battery operating parameters 130. Based on the set of target battery operating parameters 130, the grid balancing unit 150 may operate the bidirectional charging interface 172 to charge the battery 176 from the electrical grid, discharge the battery 176 to the electrical grid 100, or neither charge nor discharge the battery 176.

In some examples, the user device 171 displays at least one value indicating at least one operating parameter determined by the grid balancing unit 150. For example, the user device 171 may display the power transfer rate.

In some further examples, (block 470) generating, at the grid balancing unit 150, and transmitting from the grid balancing unit 150 to each electric vehicle unit 178 a set of target battery operating parameters further comprises assigning the target charge-discharge rate 131 to each electric vehicle 170 based on the vehicle location 121.

In some further examples, the grid balancing unit 150 is communicatively coupled with the grid controller 104 via the grid-system communication channel 182, as illustrated in FIG. 3A. In these examples, the grid balancing unit 150 receives the set of grid operating parameters 110 via the grid-system communication channel 182. In some other further examples, the electrical grid 100 comprises the grid balancing unit 150.

In some examples, the method 400 proceeds with (block 480), receiving, at the grid balancing unit 150 from each electric vehicle unit 178 connected with the grid balancing unit 150, a set of current battery operating parameters 140 for each electric vehicle unit 178. The grid balancing unit 150 receives the set of current battery operating parameters 140 through the system-vehicle communication channel 184. The set of current battery operating parameters 140 comprises at least one selected from the group consisting of a current charge-discharge rate 141 and battery operating temperatures. For example, receiving at the grid balancing unit 150 battery operating temperatures would allow prioritizing electric vehicles 170 that will not require additional conditioning for the battery 176 to reach an optimal temperature range. Specifically, it would allow prioritizing electric vehicles 170 with battery operating temperatures greater than 0° Celsius for charging.

In some examples, the method 400 proceeds with (block 490) updating, at the grid balancing unit 150, the set of target battery operating parameters 130 for each electric vehicle unit 178. The set of target battery operating parameters 130 is updated based on the set of current battery operating parameters 140. In some examples, (a) receiving the set of current battery operating parameters 140, and (b) updating the set of target battery operating parameters 130, is continuously repeated. In some other examples, (a) receiving the set of grid operating parameters 110, (b) generating the system charge-discharge rate 152, (c) generating and transmitting the set of target battery operating parameters 130 for each electric vehicle unit 178, (d) receiving the set of current battery operating parameters 140, and (e) updating the set of target battery operating parameters 130, is continuously repeated.

### Examples of Connecting Electric Vehicles with Electric Grids

In some examples, the system-vehicle communication channel 184 communicatively couples at least one electric vehicle unit 178 with the grid balancing unit 150 through the user device 171.

Returning to FIG. 2, in some examples, as described above, the electric vehicle unit 178 comprises the bidirectional charging interface 172. The bidirectional charging interface 172 is associated with and electrically coupled to the electric vehicle 170. In these examples, the system-vehicle communication channel 184 is communicatively coupled with at least one bidirectional charging interface 172, which is communicatively coupled with at least one electric vehicle unit 178.

In some examples, the user device 171 is physically separated from the electric vehicle 170 and is communicatively coupled to each of the bidirectional charging interface 172 and the grid controller 104. In these examples, the user device 171 is selected from the group consisting of a mobile phone, a computer, a laptop computer, a smart home device, and a smart power meter. In some examples, one user device 171 is communicatively coupled with more than one, more than two, more than 5, or even more than 10 electric vehicles 170.

In some examples, the bidirectional charging interface 172 is electrically coupled to the electrical grid 100 and controls electrical power supplied to the battery 176 from the electrical grid 100 and drawn from the battery 176 to the electrical grid 100.

In some further examples, the electric vehicle 170 comprises the bidirectional charging interface 172. In these examples, the bidirectional charging interface 172 comprises an inverter. The bidirectional charging interface 172 is reversibly connected to and exchanges alternating current with the electrical grid 100. In some yet further examples, the bidirectional charging interface 172 is reversibly connected to and exchanges direct current with the electric vehicle 170.

In some examples, the bidirectional charging interface 172 is fully controlled based on the set of target battery operating parameters 130 received from the grid balancing unit 150. In some further examples, the bidirectional charging interface 172 may be controlled by the grid balancing unit 150.

### Examples of Selecting Subsets of Electric Vehicles

In some examples, in the method 400, generating, at the grid balancing unit 150, a system charge-discharge rate 152 may comprise (block 461) identifying a power deficiency level based on the current power demand 111 exceeding the current power supply 112, and (block 462) selecting a first vehicle subset from the set of multiple electric vehicle units 179 based on the current battery SOC 124 exceeding the minimum battery SOC 125a. In identifying a power deficiency level based on the current power demand 111 and the current power supply 112, the grid balancing unit 150 may identify that the current power demand 111 received from the grid controller 104 exceeds the current power supply 112 received from the grid controller 104. The grid balancing unit 150 may then select a first vehicle subset from the set of multiple electric vehicle units 179. The grid balancing unit 150 may select electric vehicles that have a current battery SOC 124 exceeding the minimum battery SOC 125a. In this example, selected electric vehicles 170 comprise batteries with a charge above the minimum battery SOC 125a.

In some examples, (block 462) selecting the first vehicle subset is further based on the greatest difference between the current battery SOC 124 and the minimum battery SOC 125a. In other words, in these examples, the grid balancing unit 150 selects one or more electric vehicles 170 with the greatest capacity for providing electrical charge to the electrical grid 100 without discharging the battery 176 to the minimum battery SOC 125a to be in the first vehicle subset. In further examples, (block 462) selecting the first vehicle subset is further based on the current battery SOC 124 and whether the vehicle location 121 corresponds to a location within the grid boundary 108.

In some examples, (block 462) selecting the first vehicle subset is further based on the vehicle power transmission limit 122. In these examples, the combined value of the vehicle power transmission limit 122 in the first vehicle subset may exceed the power deficiency level. In further examples, (block 462) selecting the first vehicle subset is further based on a difference between a current time and the start travel time 126a exceeding a set timing threshold. In these examples, the grid balancing unit 150 may select one or more electric vehicles 170 for the first vehicle subset that has a start travel time 126a later than the current time. In other words, electric vehicles 170 that are expected to be disconnected from the electrical grid 100 may not be included in the first vehicle subset. In further examples, the grid balancing unit 150 may select for the first vehicle subset with a start travel time 126a later than the current time.

In some examples, (block 462) selecting the first vehicle subset is further based on the highest value of the battery capacity 123. In other words, in this example, the grid balancing unit 150 may select (for the first vehicle subset) the electric vehicles 170 with the greatest capacity to provide power to the electrical grid 100. In some examples, the first vehicle subset may be selected such that it comprises the fewest number of electric vehicles 170 capable of providing an amount of power to the electrical grid 100.

In some examples, (block 462) selecting the first vehicle subset is further based on the lowest value of the power-supplying price 127a. In other words, the grid balancing unit 150 may select the first vehicle subset such that the electric vehicles 170 in the first vehicle subset will provide electrical power to the electrical grid 100 at the lowest average price.

In some examples, in the method 400, determining the set of target battery operating parameters 130 comprises (block 473) identifying a power excess level based on the current power supply 112 exceeding the current power demand 111, and (block 474) selecting a second vehicle subset from the set of multiple electric vehicle units 179 based on the current battery SOC 124 being less than the maximum battery SOC 125b. In identifying a power excess level based on the current power supply 112 exceeding the current power demand 111, the grid balancing unit 150 may identify that the current power supply 112 received from the grid controller 104 exceeds the current power demand 111 received from the grid controller 104. The grid balancing unit 150 may then select a second vehicle subset from the set of multiple electric vehicle units 179. The grid balancing unit 150 may select electric vehicles that have a current battery SOC 124 that is less than the maximum battery SOC 125b to be included in the second vehicle subset. In some further examples, selecting the second vehicle subset may further be based on the vehicle power transmission limit 122. Specifically, the grid balancing unit 150 may further select electric vehicles 170 for the second vehicle subset such that a combined value of the vehicle power transmission limit 122 in the second vehicle subset exceeds the power excess level.

In some other examples, the grid balancing unit 150 may select the second vehicle subset further based on the highest value of the battery capacity 123. In other words, the grid balancing unit 150 may select vehicles in the second vehicle subset with the highest battery capacity of electric vehicles 170 connected to the grid balancing unit 150.

In some examples, a total battery capacity in the set of multiple electric vehicle units 179 is represented as a sum of the battery capacity 123 of each electric vehicle unit 178. In some further examples, the total battery capacity is at least 10 MWh. For example, the total battery capacity may be more than 500 kWh, more than 1 megawatt-hour (MWH), more than 5 MWh, or even more than 20 MWh. In some examples, the battery capacity 123 of each electric vehicle unit 178 is at least 10 kWh. For example, the battery capacity 123 of each electric vehicle unit 178 is at least 15 kWh, at least 25 kWh, at least 50 kWh, or even at least 100 kWh.

In selecting a first vehicle subset and/or a second vehicle subset, the grid balancing unit 150 selecting an electric vehicle 170 may include the grid balancing unit 150 instructing the electric vehicle 170 to form an electrical connection with the electrical grid 100.

In some examples, the electric vehicle 170 is not selected to be included in a first vehicle subset or second vehicle subset because the user device 171 has recorded an exclude command. The exclude command may be reversibly selected, for example, by a vehicle user. In these examples, the electric vehicle 170 will not be charged or discharged, but may remain communicatively coupled with the grid balancing unit 150.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A method of balancing an electrical grid using a grid balancing unit, the electrical grid is defined by a grid boundary and comprising a grid controller, the method comprising:
forming a system-vehicle communication channel between the grid balancing unit and at least one electric vehicle unit in a set of multiple electric vehicle units, wherein each electric vehicle unit comprises an electric vehicle comprising a battery;
receiving, at the grid balancing unit and through the system-vehicle communication channel, a set of vehicle unit parameters associated with the at least one electric vehicle unit, connected with the grid balancing unit through the system-vehicle communication channel, wherein the set of vehicle unit parameters comprises at least one parameter selected from the group consisting of a vehicle location within the grid boundary, a vehicle power transmission limit, a battery capacity, a current battery SOC, a minimum battery SOC, a maximum battery SOC, a start travel time, a start-travel minimum battery SOC, a power-supplying price, a power-receiving price, a minimum battery charge rate, and a maximum battery charge rate;
generating, at the grid balancing unit, at least one of a current battery power availability and a current battery energy availability for the at least one electric vehicle unit, based on the set of vehicle unit parameters; and
transmitting to the grid controller, by the grid balancing unit, at least one of the current battery power availability and the current battery energy availability.

2. The method of claim 1, further comprising:
receiving, at the grid balancing unit from the grid controller, a set of grid operating parameters associated with the electrical grid and comprising at least one selected from the group consisting of a current power demand, a current power supply, a current energy demand, and a current energy supply;
generating, at the grid balancing unit, a system charge-discharge rate based on the set of grid operating parameters; and
generating, at the grid balancing unit and based on the set of vehicle unit parameters and the system charge-discharge rate and transmitting from the grid balancing unit to each electric vehicle unit through the system-vehicle communication channel, a set of target battery operating parameters for each electric vehicle unit and comprising at least one selected from the group consisting of a target charge-discharge rate, a current battery power demand, a current battery energy demand, and a current battery power availability.

3. The method of claim 2, further comprising:
receiving, at the grid balancing unit and through the system-vehicle communication channel from each electric vehicle unit connected with the grid balancing unit through the system-vehicle communication channel, a set of current battery operating parameters for each electric vehicle unit and comprising at least one selected from the group consisting of a current charge-discharge rate, and battery operating temperatures; and
updating, at the grid balancing unit and based on the set of current battery operating parameters, the set of target battery operating parameters for each electric vehicle unit.

4. The method of claim 3, wherein (a) receiving the set of grid operating parameters, (b) generating the system charge-discharge rate, (c) generating and transmitting the set of target battery operating parameters for each electric vehicle unit, (d) receiving the set of vehicle unit parameters, and (e) updating the set of target battery operating parameters, are continuously repeated.

5. The method of claim 2, wherein the electric vehicle unit further comprises a bidirectional charging interface associated with and electrically coupled to the electric vehicle.

6. The method of claim 5, wherein the bidirectional charging interface is fully controlled based on the set of target battery operating parameters received from the grid balancing unit.

7. The method of claim 5, wherein the system-vehicle communication channel is communicatively coupled with at least one bidirectional charging interface which is communicatively coupled with the at least one electric vehicle unit.

8. The method of claim 7, wherein:
each electric vehicle unit comprises a user device associated with and communicatively coupled to the electric vehicle,
the user device is physically separated from the electric vehicle and is communicatively coupled to each of the bidirectional charging interface and the grid controller, and
the user device is selected from the group consisting of a mobile telephone, a tablet computer, a laptop computer, a smart home device, and a smart power meter.

9. The method of claim 8, wherein the system-vehicle communication channel communicatively couples the at least one electric vehicle unit with the grid balancing unit through the user device.

10. The method of claim 2, wherein generating, at the grid balancing unit, a system charge-discharge rate comprises:
identifying a power deficiency level based on the current power demand exceeding the current power supply, and
selecting a first vehicle subset from the set of multiple electric vehicle units based on the current battery SOC exceeding the minimum battery SOC.

11. The method of claim 10, wherein selecting the first vehicle subset is further based on a greatest difference between the current battery SOC and the minimum battery SOC.

12. The method of claim 10, wherein selecting the first vehicle subset is further based on the vehicle power transmission limit such that a combined value of the vehicle power transmission limit in the first vehicle subset exceeds the power deficiency level.

13. The method of claim 10, wherein selecting the first vehicle subset is further based on a difference between a current time and the start travel time exceeding a set timing threshold.

14. The method of claim 10, wherein selecting the first vehicle subset is further based on a highest value of the battery capacity.

15. The method of claim 10, wherein selecting the first vehicle subset is further based on a lowest value of the power-supplying price.

16. The method of claim 10, wherein generating, at the grid balancing unit and based on the set of vehicle unit parameters and the system charge-discharge rate and transmitting from the grid balancing unit to each electric vehicle unit through the system-vehicle communication channel further comprises assigning the target charge-discharge rate to each electric vehicle based on the vehicle location.

17. The method of claim 2, wherein generating, at the grid balancing unit and based on the set of vehicle unit parameters and the system charge-discharge rate and transmitting from the grid balancing unit to each electric vehicle unit through the system-vehicle communication channel comprises:
identifying a power excess level based on the current power supply exceeding the current power demand, and
selecting a second vehicle subset from the set of multiple electric vehicle units based on the current battery SOC being less than the maximum battery SOC.

18. The method of claim 17, wherein selecting the second vehicle subset is further based on the vehicle power transmission limit such that a combined value of the vehicle power transmission limit in the second vehicle subset exceeds the power excess level.

19. The method of claim 17, wherein selecting the second vehicle subset is further based on a highest value of the battery capacity.

20. A grid balancing unit comprising a processor and a computer-readable storage medium storing instructions that, when executed by the processor, cause the grid balancing unit to perform a method of balancing an electrical grid defined by a grid boundary and comprising a grid controller, the method comprising:
forming a system-vehicle communication channel between the grid balancing unit and at least one electric vehicle unit in a set of multiple electric vehicle units, wherein each electric vehicle unit comprises an electric vehicle comprising a battery;
receiving, at the grid balancing unit and through the system-vehicle communication channel, a set of vehicle unit parameters associated with the at least one electric vehicle unit connected with the grid balancing unit through the system-vehicle communication channel and comprising at least one selected from the group consisting of a vehicle location within the grid boundary, a vehicle power transmission limit, a battery capacity, a current battery SOC, a minimum battery SOC, a maximum battery SOC, a start travel time, a start-travel minimum battery SOC, a power-supplying price, a power-receiving price, a minimum battery charge rate, and a maximum battery charge rate;
generating, at the grid balancing unit, at least one of a current battery power availability and a current battery energy availability for the set of multiple electric vehicle units, based on the set of vehicle unit parameters; and
transmitting to the grid controller, by the grid balancing unit, at least one of the current battery power availability and the current battery energy availability.
